(19) United States
(12) Patent Application Publication
(10) Pub. No.: US 2021/0285342 A1
(43) Pub. Date: Sep. 16, 2021

(54) THE METHOD OF CONVERSION OF THERMAL ENERGY INTO MECHANICAL ENERGY AND A THERMO-HYDRODYNAMIC CONVERTER

(71) Applicant: Józef Kowalczyk, Kamesznica (PL)

(72) Inventor: Józef Kowalczyk, Kamesznica (PL)

(21) Appl. No.: 16/325,145

(22) PCT Filed: Aug. 2, 2017
(86) PCT No.: PCT/PL2017/000076

§ 371 Date: Feb. 12, 2019

(30) Foreign Application Priority Data
Aug. 3, 2016 (PL) P.418192

(51) Int. Cl. F01K 27/00; F01K 3/00; F03B 17/00; F01K 3/18

(52) U.S. Cl. CPC F01K 27/005; F01K 3/18; F03B 17/005; F01K 3/004

(57) ABSTRACT

The subject of the invention is the method of conversion of thermal energy into mechanical energy and a thermo-hydrodynamic converter in which the said conversion occurs, which is the result of combustion of the fuel in the boiler in which generated steam is directed to converter vessels, whereas during continuous operation the steam is reheated and it is repeatedly used in converter units of different pressures.

The method of conversion of thermal energy into mechanical energy for power generation consists in that water is heated in the boiler (kp) to obtain steam that is supplied under the pressure of about 100 atm and at the temperature of about 500° C. to the vessel (tk1) from where it forces out the water accumulated in the vessel, which flowing out from the vessel (tk1) drives the water turbine (10) and this water turbine drives the power generator (11), and then the water is supplied to the vessel (tk2) from where it is forced out by the steam supplied from the boiler (kp), which water flowing out from the vessel (tk2) drives the water turbine (10) and this water turbine drives the power generator (11), and then this water is supplied to the vessel (tk3) from where it is forced out by the steam supplied from the boiler (kp), which water flowing out from the vessel (tk3) drives the water turbine (10) and this water turbine drives the power generator (11), and then this water is supplied to the vessel (tk4) from where it is forced out by the steam supplied from the boiler (kp), which water flowing out from the vessel (tk4) drives the water turbine (10) and this water turbine drives the power generator (11), whereby the water returns to the vessel (tk1), and the steam from the vessel (tk4) returns to the boiler (kp) preheating the steam produced there and the working cycle of the vessels (tk1), (tk2), (tk3), (tk4) of the converter is repeated from the beginning.

The subject of the invention is the method of conversion of thermal energy into mechanical energy and a thermo-hydrodynamic converter in which the said conversion occurs, which is the result of combustion of fuel in the boiler in which the steam generated is directed to converter vessels and the steam pressure converted to mechanical energy. The hot steam is directed back to the boiler to reheat supplied water.

In the coal-fired power plants, nuclear power plants or power plants using biogas as fuel currently used worldwide, combustion of fuels in boilers is applied, as a result of which the heat obtained from fuels combustion heats up water supplied to the boilers, which is converted into steam of the high pressure of about 100 atm and the temperature of about 500° C. This steam is then supplied to the steam turbines that are equipped with rotors seated on drive shafts and equipped with blades onto which the steam produced under high pressure is supplied, thereby creating the rotary movement of the turbine shaft. In this way kinetic energy of the steam is partly converted into mechanical energy. The power obtained from the turbine depends on the flow rate of the steam, its specific weight and the working surfaces of rotor blades. The efficiency of steam turbines is very low and it is established as the maximum of 30% to 38%. The cause of such low efficiency is mainly the low specific weight of the steam and its low density, which makes it miss the turbine blades, flow between them and thus reduce the turbine efficiency. After leaving the turbines the steam still has high pressure parameters and temperature and due to technical considerations it cannot be fully used and needs to be cooled down before it is released into the atmosphere.

The purpose of the invention is to develop a method of conversion of the heat from fuels combustion into mechanical energy in the thermo-hydrodynamic process occurring in a thermo-hydrodynamic converter in which some physical phenomena are used, such as conversion of the steam pressure into the fluid pressure, in particular the pressure of water that flows between converter vessels in which it is repeatedly used in the circuits of different pressure levels, and where the remaining steam present in the converters of the reduced pressure, which retains almost 100% of the heat energy, can be redirected to the boilers to be used to pre-heat water, whereby this process occurs in a closed circulation system.

The method of conversion of thermal energy into mechanical energy for electricity generation by combustion of known fuels in boilers and heating water with the obtained heat according to the invention is characterised by that in a boiler (kp) water is heated to obtain steam that is supplied under the pressure of about 100 atm and at the temperature of about 500° C. to the first vessel from where it forces out the water accumulated in the vessel, which flowing out from the first vessel drives the water turbine, and the water turbine drives the power generator, and then the water is supplied to the second vessel from where it is forced out by the steam supplied from the boiler, and the said water flowing out from the second vessel drives the water turbine, and this water turbine drives the power generator, and then this water is supplied to the third vessel from where it is forced out by the steam supplied from the boiler, and this water flowing out from the third vessel drives the water turbine, and this water turbine drives the power generator, and then this water is supplied to the fourth vessel from where it is forced out by the steam supplied from the boiler, and this water flowing out from the fourth vessel drives the water turbine, and this water turbine drives the power generator, whereby the water returns to the first vessel and the steam from the fourth vessel returns to the boiler preheating the steam produced there and the water, and the working cycle of the converter vessels is repeated.

A thermo-hydro converter according to the invention is characterised by that it comprises at least two pressure vessels, and in particular four vessels, or sections of vessels inside of which there is located a thermal insulator separating the steam chamber from the water chamber, whereby to the vessels, and in particular four vessels or sections of the vessels, steam system pipes, steam inlet and outlet system pipes, steam return system pipes, water return system pipes, water system pipes are delivered that are connected with control valves, relay valves, and outlet valves are connected with the turbines cooperating with power generators. The section of vessels A is the section of high pressure of about 100 atm, the section of vessels B is the section of medium pressure of about 50 atm, and the section of vessels C is the section of low pressure of about 25 atm. In the top part of each pressure vessel there is a maintenance opening, while in the bottom there is a drain valve. Water is used as hydraulic fluid in converters.

The advantage of the method of electricity production and of the application of the thermo-hydro converter is that greater efficiency of the turbine and the power generation system is obtained in comparison with the known methods of electricity production obtained from fuels combustion, which shall result in the decrease of emission of the thermal energy to atmosphere and water consumption, which in the solution according to the invention is used in a closed cycle, and thus practically in a lossless cycle that does not cause the increase of global warming.

Embodiment. The method of conversion of thermal energy into mechanical energy for production of electricity by combustion of known fuels in boilers and heating water with the obtained heat consists in that in the boiler kp water is heated to obtain steam which is supplied under the pressure of 100 atm and at the temperature of 500° C. to the vessel tk1 from where it forces out the water accumulated in the vessel, which flowing out from the vessel tk1 drives the water turbine 10, and this turbine drives the power generator 11, and then the water is supplied to the vessel tk2 from where it is forced out by the steam supplied from the boiler kp, the said water flowing out from the vessel tk2 drives the water turbine 10, and this turbine drives the power generator 11, and then the said water is supplied to the vessel tk3 from where it is forced out by the steam supplied from the boiler kp, and the said water flowing out from the vessel tk3 drives the water turbine 10, and this turbine drives the power generator 11, and then the said water is supplied to the vessel tk4 from where it is forced out by the steam supplied from the boiler kp, and the said water flowing out from the vessel tk4 drives the water turbine 10, and this turbine drives the power generator 11, whereby the water returns to the vessel tk1, and the steam from all the vessel returns to the boiler kp preheating the steam produced there and the water, and the working cycle of the converter vessels is repeated from the beginning.

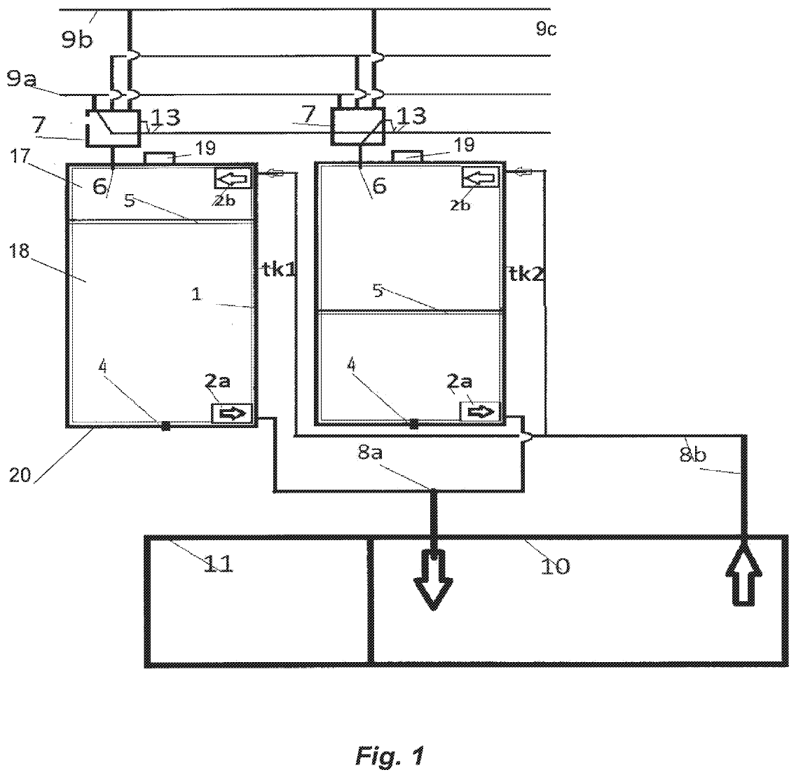

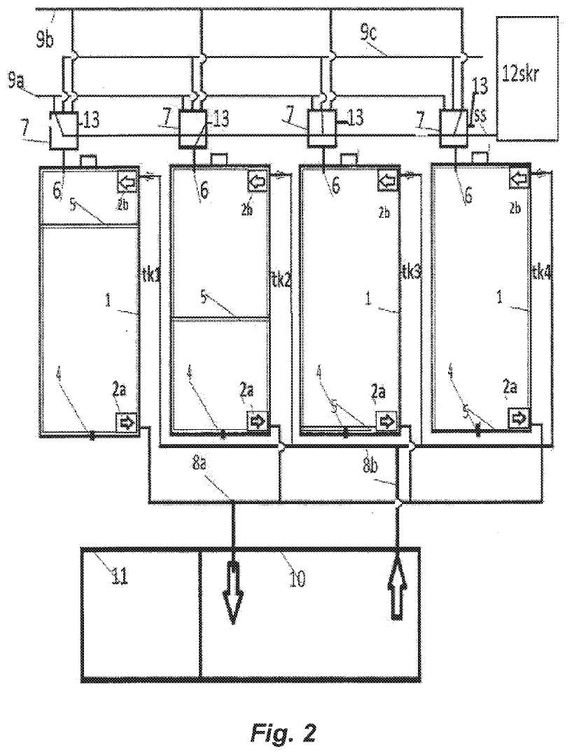

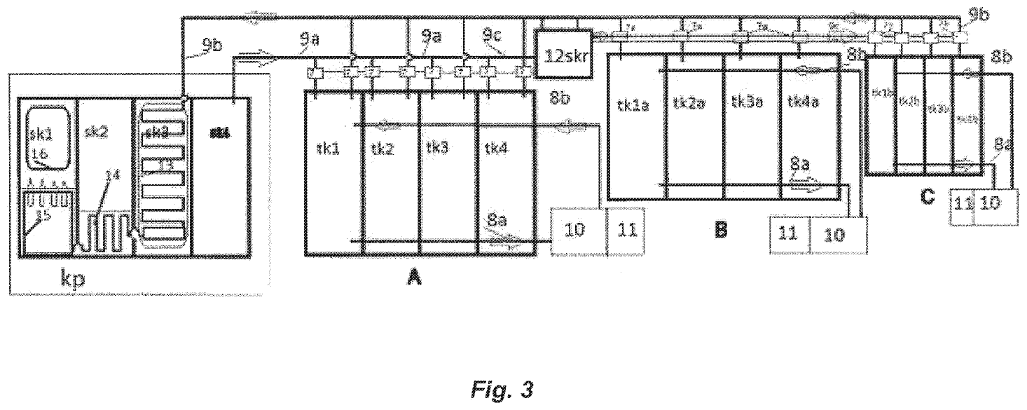

The subject of the invention is presented in the drawing, where FIG. 1 presents the thermo-hydrodynamic converter consisting of two vessels, FIG. 2 presents the thermo-hydrodynamic converter consisting of four vessels, and FIG. 3 presents a technological system consisting of three sections of thermo-hydrodynamic converters containing four vessels each, of various pressure stages.

As it is illustrated in the drawing, the thermo-hydro converter presented in FIG. 1 consists of two vessels, where each of them is constructed from side walls 1, a bottom 20 with a water drain 4, the vessel cover with a maintenance inlet 3, a valve and an outlet of water to the network 2a onto the turbines 10, a valve and an inlet of the return water from the turbine 2b, an inlet and an outlet of the steam system 6 and a valve of the steam relay 7. The water surface and internal side walls are covered with a layer of thermal insulation.

This converter operates on the principle that the vessel tk1 is almost fully filled with water and through networks 9a and a controlled valve 7 steam of the temperature of about 500° C. and the pressure of about 100 atm is supplied under the pressure of 100 atm through the inlet 6 to the top part of this vessel. The steam fills the space above the water surface 5 and affects the water surface 5 with its pressure, and the pressure increases by the value of the pressure of the supplied steam. Water under increased pressure is supplied through the opened valve 2a and the water networks 8a from the vessel tk1 onto the water turbines 10 combined with the power generators 11. After the water flows through the turbines 10, it is taken through the return networks 8b to another vessel tk2, whereby during the flowing out of the water from the vessel tk1 the valve 2b is closed and the steam is supplied through the networks 9a through the open valve 7 which results in constant steam supply and maintaining constant pressure and filling the released space through the outflow of water, and maintenance of constant and high pressure of steam and water until the vessel tk1 is emptied, which constitutes a working cycle of the converter. To obtain the continuity of operation at least two, and in particular more converter vessels need to cooperate with each other, creating an exemplary converter unit presented in FIG. 2 consisting of four converters tk1, tk2, tk3, tk4. The operation of this unit shall be such that the steam of the temperature of about 500° C. and the pressure of about 100 atm that forces out water is supplied to the vessel tk1, and this water flows through the hydraulic turbine 10 driving the power generator 11 and returns through the networks b to the vessel tk2 filling it up, and then the steam of the temperature of about 500° C. and the pressure of about 100 atm supplied to it forces out water, and this water flows through the hydraulic turbine 10 driving the power generator 11 and returns through the networks 9b to the vessel tk3 filling it up, and then the steam of the temperature of about 500° C. and the pressure of about 100 atm supplied to it forces out water, and this water flows through the hydraulic turbine 10 driving the power generator 11 and returns through the networks 9b to the vessel tk4 filling it up, and then the steam of the temperature of about 500° C. and the pressure of about 100 atm supplied to it forces out water, and this water flows through the hydraulic turbine 10 driving the power generator 11 and returns through the networks 9b to the vessel tk1 filling it up, which constitutes the working cycle of four converters tk1, tk2, tk3, tk4.

The subject of the invention can also be applied in an exemplary technological system consisting of three sections A, B, C of thermo-hydrodynamic converters containing four high pressure vessels tk1, tk2, tk3, tk4 of the pressure of about 100 atm, medium pressure vessels tk1a, tk2a, tk3a, tk4a of the pressure of about 50 atm and low pressure vessels tk1b, tk2b, tk3b, tk4b of the pressure of about 25 atm, respectively, as it is presented in the embodiment in FIG. 3. This system consists of water network systems 8a, 8b and steam network systems 9a, 9b, 9c, control networks 13 of steam and water valves sg and a control room with a controller for controlling and regulation of the system 12skr.

The operation of the complete thermo-hydrodynamic technological system (FIG. 3) consists in that the steam supplied from the steam boilers through the networks 9a to the high pressure converter unit A sets it into continuous operation, at the same time the remaining steam from the converters is introduced onto converters B operating at lower pressures of 50 atm. After using the pressure in the converters C of low pressure circuits the steam of the high temperature of 500° C. and the low pressure of about 25 atm is supplied back through the networks 9b to the steam boiler kp to the section sk3 of the steam superheater 13. In the section sk3 this steam moving inside the superheater 13 heats up the colder steam accumulated in there, increasing its temperature and pressure. After leaving the superheater 13, the steam is introduced into the section of the water heater 14 located in the bottom part of the section sk2. From the water heater 14 the steam is supplied to the injector 15 of the section sk1. In the section sk1 the steam is injected into the water from where it escapes and through the water jacket it heats the water and escaping above the surface of the water it is cooled down so that it can be used again in sections sk2, sk3 and sk4, where it is heated up to the temperature of 500° C. with the heat from fuels combustion and it reaches the pressure of about 100 atm in the boiler kp, from where it goes to the converters units A, B and C.

1. The method of conversion of thermal energy into mechanical energy for electricity generation by combustion of known fuels in boilers and heating water with the obtained heat characterised by that in the boiler (kp) water is heated to obtain steam that is supplied under the pressure of about 100 atm and at the temperature of about 500° C. to the vessel (tk1) from where it forces out the water accumulated in the vessel, which flowing out from the vessel (tk1) drives the water turbine (10) and this water turbine drives the power generator (11), and then the water is supplied to the vessel (tk2) from where it is forced out by the steam supplied from the boiler (kp), which water flowing out from the vessel (tk2) drives the water turbine (10) and this water turbine drives the power generator (11), and then this water is supplied to the vessel (tk3) from where it is forced out by the steam supplied from the boiler (kp), which water flowing out from the vessel (tk3) drives the water turbine (10) and this water turbine drives the power generator (11), and then this water is supplied to the vessel (tk4) from where it is forced out by the steam supplied from the boiler (kp), which water flowing out from the vessel (tk4) drives the water turbine (10) and this water turbine drives the power generator (11), whereby this water returns to the vessel (tk1), and the steam from the vessel (tk4), and the steam from all the vessels returns to the boiler (kp) preheating the steam produced there and the water, or could be used for residential or commercial heating systems, and the working cycle of the vessels (tk1), (tk2), (tk3), (tk4) of the converter is repeated from the beginning.

2. A thermo-hydro converter according to claim 1 characterised by that it consists of at least two pressure vessels (tk1), (tk2), and in particular of four vessels (tk1), (tk2), (tk3), (tk4) or sections of the vessels (A), (B), (C) inside of which there is a thermal insulator (5) separating the steam chamber (17) from the water chamber (18), whereby to the vessels (tk1), (tk2), and in particular to the four vessels (tk1), (tk2), (tk3), (tk4) or sections of the vessels (A), (B), (C) pipes (9a) of steam system, pipes (6) of steam inlet and outlet system, pipes (9b) of steam return system, pipes (8b) of water return system, pipes of water system (8a) are delivered that are connected with control valves (13), relay valves (7), and outlet valves (2a) are connected with the turbines (10) cooperating with the power generators (11).

3. A thermo-hydro converter according to claim 2 characterised by that at least two pressure vessels (tk1), (tk2) are equipped with the water circuit (8a), (8b) and the steam circuit (9a), (9b), (9c) operating in the closed circuit.

4. A thermo-hydro converter according to claim 2 or 3 characterised by that a section of vessels (A) is the section of high pressure of about 100 atm, a section of vessels (B) is the section of medium pressure of about 50 atm, and a section of vessels (C) is the section of low pressure of about 25 atm.

5. A thermo-hydro converter according to claim 2 characterised by that in the top part of the pressure vessel (tk1) or (tk2) or (tk3) or (tk4) there is a maintenance opening (19), whereas in the bottom (20) there is a drain valve (4).

6. A thermo-hydro converter according to claim 2 or 3 characterised by that water is used as hydraulic fluid.
